(19) United States
(12) Patent Application Publication
(10) Pub. No.: US 2025/0110562 A1
(43) Pub. Date: Apr. 3, 2025

(54) VIBRATION CONTROL METHOD AND APPARATUS, COMPUTER DEVICE, AND STORAGE MEDIUM

(71) Applicant: Tencent Technology (Shenzhen ) Company Limited, Shenzhen (CN)

(72) Inventors: Shili XU, Shenzhen (CN); Lina Gao, Shenzhen (CN); Siliang Liu, Shenzhen (CN); Kai Hong, Shenzhen (CN); Xun Sun, Shenzhen (CN); Yitao Zhao, Shenzhen (CN); Lei Feng, Shenzhen (CN)

(73) Assignee: Tencent Technology (Shenzhen ) Company Limited, Shenzhen (CN)

(21) Appl. No.: 18/979,765

(22) Filed: Dec. 13, 2024

Related U.S. Application Data
(63) Continuation of application No. PCT/CN2023/079106, filed on Mar. 1, 2023.

(30) Foreign Application Priority Data
Jun. 16, 2022 (CN) 202210684977.4

(51) Int. Cl. G06F 3/01; G06F 3/0488; G06F 3/16

(52) U.S. Cl. CPC G06F 3/016; G06F 3/0488; G06F 3/167

(57) ABSTRACT

A vibration control method, includes: displaying an element control region including first control elements that includes one or more anchor elements and non-anchor elements; receiving a triggering operation performed on a first control element; and outputting a vibration associated with at least one acted control element based on the triggering operation acting on at least one of the first control elements, wherein, based on the at least one acted control element being an anchor element, the outputting the vibration includes outputting an anchor vibration; and the method further includes determining output information corresponding to the at least one acted control element based on the anchor vibration, and wherein, based on the at least one acted control element being a non-anchor element, the method further includes determining the output information based on the anchor vibration, a layout of the element control region, and an operation track of the triggering operation.

### CROSS-REFERENCE TO RELATED APPLICATIONS

This application is a continuation application of International Application No. PCT/CN2023/079106 filed on Mar. 1, 2023, which claims priority to Chinese Patent Application No. 202210684977.4, filed with the China National Intellectual Property Administration on Jun. 16, 2022, the disclosures of each being incorporated by reference herein in their entireties.

### FIELD

The disclosure relates to the field of computer technologies, and in particular, to a vibration control method and apparatus, a computer device, and a storage medium.

### BACKGROUND

With the continuous in-depth development of computer technologies, information output based on computer devices can effectively improve the convenience of relevant users in the production and life process. To make the corresponding objects more interactive during information input, when the corresponding objects perform information input, interactive feedback forms, for example, voice feedback have been attempted to be used to meet the users' input needs. However, current interactive feedback forms provided during information input may creation information security issues. Therefore, effectively performing interactive feedback during information input while mitigating information security issues has become a current research focus.

### SUMMARY

Provided are a vibration control method and apparatus, a computer device, and a storage medium, capable of performing interactive feedback during information input.

According to some embodiments, a vibration control method includes: displaying an element control region including a first plurality of control elements, wherein the first plurality of control elements includes one or more anchor elements and a plurality of non-anchor elements; receiving a triggering operation performed on a first control element of the first plurality of control elements; and outputting a vibration associated with at least one acted control element of the first plurality of control elements based on the triggering operation acting on at least one of the first plurality of control elements, wherein, based on the at least one acted control element being an anchor element, the outputting the vibration includes outputting an anchor vibration; and the method further includes determining output information corresponding to the at least one acted control element based on the anchor vibration, and wherein, based on the at least one acted control element being a non-anchor element, the method further includes determining the output information based on the anchor vibration, a layout of the element control region, and an operation track of the triggering operation.

According to some embodiments, a vibration control apparatus includes: at least one memory configured to store computer program code; and at least one processor configured to read the program code and operate as instructed by the program code, the program code including: display code configured to cause at least one of the at least one processor to display an element control region including a first plurality of control elements, wherein the first plurality of control elements include one or more anchor elements and a plurality of non-anchor elements non-anchor elements; triggering code configured to cause at least one of the at least one processor to receive a triggering operation performed on a first control element of the first plurality of control elements; and first output code configured to cause at least one of the at least one processor to output a vibration associated with at least one acted control element of the first plurality of control elements based on the triggering operation acting on at least one of the first plurality of control elements, and wherein the first output code is configured to cause at least one of the at least one processor to: based on the at least one acted control element being an anchor element, output an anchor vibration; and determine output information corresponding to the at least one acted control element based on the anchor vibration; and based on the acted control element being a non-anchor element, determine the output information based on the anchor vibration, a layout of the element control region, and an operation track of the triggering operation.

According to some embodiments, a non-transitory computer-readable storage medium, storing computer code which, when executed by at least one processor, causes the at least one processor to at least: display an element control region including a first plurality of control elements, wherein the first plurality of control elements include one or more anchor elements and a plurality of non-anchor elements non-anchor elements; receive a triggering operation performed on a first control element of the first plurality of control elements; and output a vibration associated with at least one acted control element of the first plurality of control elements based on the triggering operation acting on at least one of the first plurality of control elements, wherein, based on the at least one acted control element being an anchor element, the outputting the vibration includes outputting an anchor vibration; and the outputting the vibration further includes determining output information corresponding to the at least one acted control element based on the anchor vibration, and wherein, based on the at least one acted control element being a non-anchor element, the outputting the vibration further includes determining the output information based on the anchor vibration, a layout of the element control region, and an operation track of the triggering operation.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an element control region of a target device according to some embodiments.

FIG. 2 is a schematic flowchart of a vibration control method according to some embodiments.

FIG. 3 is a schematic diagram of anchor element setting according to some embodiments.

FIG. 4 is a schematic diagram of determining a target anchor element according to some embodiments.

FIG. 5 is another schematic diagram of determining a target anchor element according to some embodiments.

FIG. 6 is a schematic diagram of performing information input based on an information input operation according to some embodiments.

FIG. 7 is a schematic diagram of performing operational output based on an operation of an acted control element according to some embodiments.

FIG. 8 is a schematic diagram of a performed cancellation operation according to some embodiments.

FIG. 9 is a schematic diagram of a vibration control method according to some embodiments.

FIG. 10 is a schematic block diagram of a vibration control apparatus according to some embodiments.

FIG. 11 is a schematic block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a vibration control method. Based on displaying an element control region in which anchor elements and non-anchor elements are laid out, a computer device may acquire a triggering operation performed on control elements from the element control region, and each time the triggering operation acts on one of the control elements, a vibration associated with the acted control element is outputted. In some embodiments, the control elements included in the element control region are respectively set as anchor elements or non-anchor elements, and the computer device presets different vibration waveforms for the anchor elements and the non-anchor elements, so that the anchor elements and the non-anchor elements correspondingly output different vibrations based on being acted on. In addition, a vibration waveform set by the computer device for an anchor element is different than a vibration waveform set for a non-anchor element. The different vibration waveform set for the anchor element refers to that: based on the corresponding anchor element being acted on, output information corresponding to the acted anchor element can be directly determined according to a vibration outputted by the corresponding different vibration waveform. Based on the different vibration waveform set for the anchor element, because the execution object of the triggering operation can directly determine the output information based on the vibration correspondingly outputted by the acted anchor element, so that the position of the acted anchor element in the element control region is directly located based on determining of the output information. In addition, for a non-anchor element acted by the triggering operation, output information of the acted non-anchor element may be determined with reference to a layout of the control elements in the element control region, an operation track of the triggering operation, and an anchor vibration outputted by an anchor element that has been acted. Based on the division of anchor elements and non-anchor elements in the element control region and the setting of different vibration waveforms for the anchor elements and the non-anchor elements by the computer device, the execution object corresponding to the triggering operation can accurately determine output information corresponding to the control element currently acted on by the triggering operation based on a vibration outputted during the execution of the triggering operation, which improves the flexibility in reminding the output information, and provides higher reminding privacy while ensuring the accuracy in reminding the output information, thereby helping to effectively improve user stickiness.

In some embodiments, the computer device may be a server or a terminal device. Based on the computer device being a terminal device, the computer device may include one or more of the following: a mobile phone, a computer, an intelligent voice interaction device, a smart home appliance, an in-vehicle terminal, or the like. Based on the computer device being a server, the computer device may be a single physical server or a server cluster including a plurality of physical servers. In some embodiments, a detailed description is provided based on a case that the computer device is a terminal device. The computer device may be a built-in processor in a server or terminal device, an external processing device, or the like, which is not limited according to some embodiments.

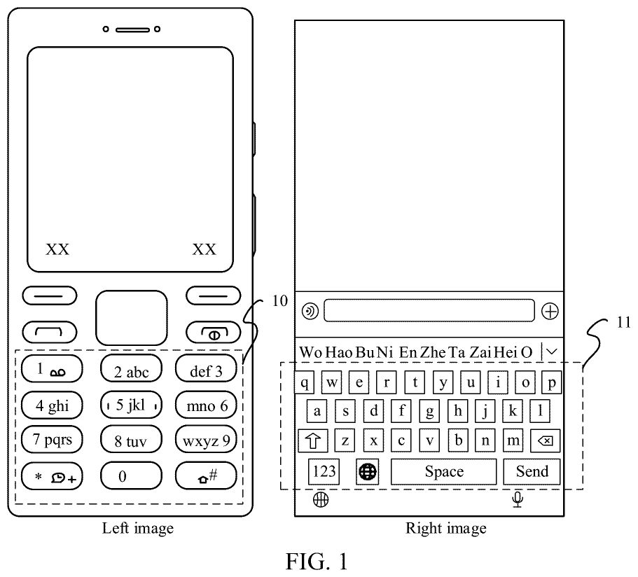

In some embodiments, a control element refers to an element that supports information output. One control element is correspondingly displayed at one position in the element control region, and the control element may be a physical element. Based on the control element being a physical element, the element control region displayed by the computer device is a physical key region in the computer device (or external to the computer device), which may be shown in the left image of FIG. 1. The region labeled by 10 in the left image of FIG. 1 is the element control region, and any physical key in the region labeled by 10 is a control element in the element control region. In some embodiments, the control element may be a touch element displayed on the device screen, and in a case that the control element is a touch element, the element control region displayed by the computer device is a touch region, which may be shown in the right image of FIG. 1. The element control region displayed as a touch region by the computer device may be the region labeled by 11 in the right image of FIG. 1. Any touch key in the region labeled by 11 is a control element in the touch region. In some embodiments, a detailed description is provided based on a case that the control element is a touch key shown in the right image of FIG. 1. Based on the control element being a physical key, reference may also be made to the embodiments of this application.

In some embodiments, the control elements included in the element control region displayed by the computer device are displayed according to a layout. For example, based on the computer device displaying the element control region, the control elements are displayed at fixed positions according to the layout, for example, the relative display positions of the control elements in the element control region remain unchanged. As shown in the left image of FIG. 1, a control element labeled by the number 1 is displayed in the upper left corner of the nine-square grid, a control element displayed to the right of the control element labeled by the number 1 is labeled by the number 2, and a control element labeled by the number 4 is displayed directly below the control element labeled by the number 1. Based on the corresponding fixed positions of the control elements in the element control region, based on acquiring the layout of the element control region, the computer device may determine output information corresponding to each acted control element with reference to an anchor vibration of an acted target anchor element and a regular vibration corresponding to a non-anchor element. For example, based on determining the difference between vibrations corresponding to different anchor elements and the vibration difference between anchor elements and non-anchor elements, the computer device may further determine output information corresponding to each control element in the element control region with reference to the layout of the element control region. Similarly, the corresponding execution object may also determine the output information corresponding to each acted control element based on the layout of the element control region, the anchor vibration of the acted target anchor element, and the regular vibration corresponding to the non-anchor element, so that the determination process of the execution object may similarly be the determination process of the computer device. In some embodiments, the control elements included in the element control region may be laid out in a nine-square grid manner (as shown in the left image of FIG. 1), or laid out in a full keyboard manner (as shown in the right image of FIG. 1). In some embodiments, the layout manner in the element control region is not limited, provided that the corresponding object is familiar with the layout manner of the element control region. The execution object corresponding to the triggering operation may be, for example, an operation object with visual impairment.

Based on the manner in which the computer device displays the plurality of control elements in the element control region according to the layout, the computer device further sets corresponding vibration waveforms for the control elements, so that based on a corresponding control element being acted on, vibration output may be performed according to the corresponding vibration waveform, so that the corresponding object can determine output information corresponding to the acted control element based on the outputted vibration. In some embodiments, the computer device may set different vibration waveforms for different control elements, so that the corresponding object may determine output information of the corresponding control element based on a vibration outputted based on each control element being acted on. In some embodiments, to reduce the learning cost of vibration learning for the object, the computer device may also differentiate between anchor elements and non-anchor elements in setting for the control elements in the element control region, and adopt the manner of setting vibration waveforms for the anchor elements and the non-anchor elements respectively, so that the corresponding object can determine the output information of the acted control elements with reference to the vibration outputted by the acted target anchor element and the vibration outputted by the acted non-anchor element.

During setting for the anchor elements, the computer device may set the anchor elements based on one or more of the layout of the plurality of control elements in the element control region, the quantity of control elements included in the element control region, and the importance (for example, being-selected probabilities) of the control elements. For example, based on the control elements being laid out in a nine-square grid, a control element in the center of the nine-square grid (for example, the control element labeled by the number 5) is set as an anchor element, or control elements at the top corners of the nine-square grid (including the control elements labeled by numbers 1, 3, 7, and 9) may be set as anchor elements; or if the control elements are in a full keyboard layout manner, a frequently used control element, for example, the control element labeled by G, may be used as an anchor element, or the control element labeled by E, the control element labeled by I, the control element labeled by G, the control element labeled by X, and the control element labeled by N may all be used as anchor elements. The setting manner of anchor elements according to some embodiments is an illustrative description, and the manner and the rule of setting the anchor elements in the element control region are not limited. Based on the setting of anchor elements of the plurality of control elements in the element control region, among the plurality of control elements in the element control region, control elements other than the set anchor elements are non-anchor elements.

In some embodiments, based on the computer device setting different vibration waveforms for the anchor elements and the non-anchor elements in the element control region, the vibration waveforms respectively set for the anchor elements and the non-anchor elements are different, so that the corresponding execution object can effectively distinguish the anchor elements and the non-anchor elements based on outputted vibrations. Based on setting vibration waveforms for different anchor elements, to determine the current positions and determine corresponding output information based on the outputted vibrations of the anchor elements, the computer device may also set different vibration waveforms for different anchor elements, so that the execution object can distinguish the anchor elements based on the outputted vibrations. For the settings of vibration waveforms of different non-anchor elements, to avoid increasing the learning burden of the execution object due to setting of an excessively large quantity of vibration waveforms, the same vibration waveform may be set for different non-anchor elements, so that the execution object may determine a selected non-anchor element with reference to an outputted vibration waveform of the anchor element and the vibration waveform corresponding to the non-anchor element. The execution object refers to an object that performs the triggering operation. The triggering operation is an operation performed by the execution object on a control element. For example, the triggering operation may be a selection operation on some of the plurality of control elements in the element control region, or the triggering operation may be a movement operation of moving in the plurality of control elements in the element control region. The selection operation on some control elements refers to sequential selection on some control elements according to a track, and the movement in the plurality of control elements is also performed according to a movement track, so that the execution object can determine the output information corresponding to the current acted control element based on the outputted vibration and the operation track indicated by the triggering operation, to improve the flexibility in reminding the output information.

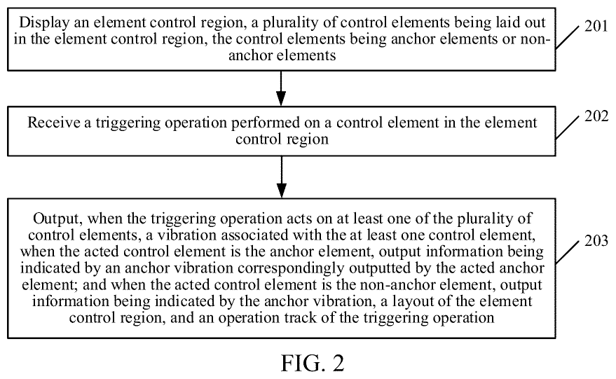

FIG. 2 is a schematic flowchart of a vibration control method according to some embodiments. As shown in FIG. 2, the method includes the following operations:

201: Display an element control region, a plurality of control elements being laid out in the element control region, the control elements being anchor elements or non-anchor elements.

The element control region may be the physical key region shown in the left image of FIG. 1, and the element control region exists as a key component of the computer device in a long-term and continuous manner. In addition, the element control region may be the touch region shown in the right image of FIG. 1. In this case, the display of the element control region as the touch region may be triggered based on detecting that information input based on the control elements in the element control region is to be acquired, for example, the element control region as the touch region is triggered for display, and the display may not be triggered based on output information being determined not to be displayed. In some embodiments, the element control region may be an external device of the computer device, such as an external keyboard and the like, and the external keyboard is also considered to continue to exist as a component of the computer device. Based on the displayed element control region, the plurality of control elements in the element control region are arranged according to a layout, and the layout manner of the plurality of control elements in the element control region may be a nine-square grid manner, or may be a full keyboard manner, or may be other layout manners, which is not limited herein.

In some embodiments, based on the element control region being a physical key region, the control elements in the element control region are fixedly laid out according to the physical key arrangement manner configured for the computer device. In a case that the element control region is a touch region, the control elements may be laid out in a nine-square grid manner, or laid out in a full keyboard manner. For example, the layout of the control elements in the element control region may be changed. In some embodiments, the layout is relatively fixed and can be familiarized and understood in advance. The corresponding execution object can learn and be familiar with the layout of the control elements displayed in the element control region by the computer device in advance, so that based on the execution object performing a triggering operation on a control element in the element control region, output information corresponding to the acted control element can be accurately determined based on a vibration outputted by the acted control element and further with reference to the learned layout, to improve the flexibility and effectiveness of the interaction between the execution object and the computer device.

The computer device distinguishes between anchor elements and non-anchor elements for the plurality of control elements. For example, the plurality of control elements included in the element control region include anchor elements and non-anchor elements.

The element control region may include one or more anchor elements; and the element control region includes a plurality of non-anchor elements.

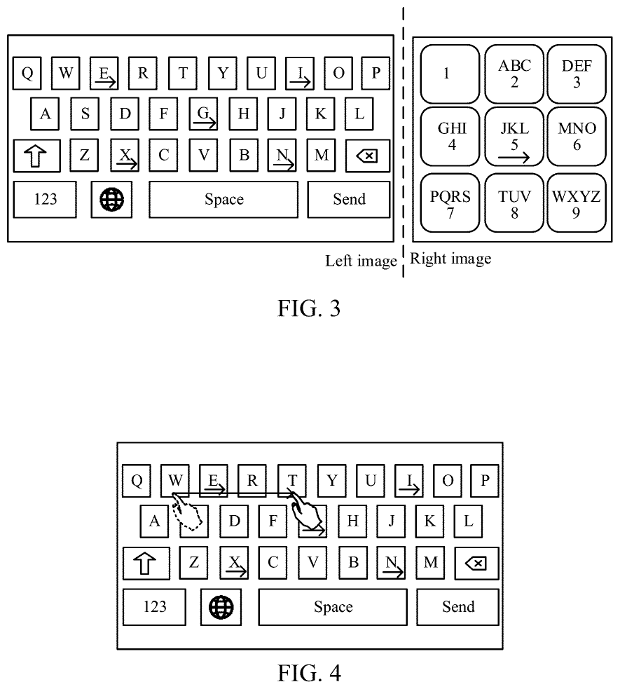

The control element being an anchor element or a non-anchor element may be preset, or may be manually configured. For example, one or more control elements are preset as anchor elements, and other control elements are automatically determined as non-anchor elements. In some embodiments, a manner in which the computer device divides anchor elements and non-anchor elements in the plurality of control elements in the element control region may be shown in FIG. 3. Based on the control elements in the element control region being displayed in a full keyboard manner, the control elements labeled by E, I, G, X, and N may be set as anchor elements, and control elements other than the anchor elements are non-anchor elements, which may be shown in the left image of FIG. 3. In a case that the control elements in the element control region are displayed in a nine-square grid manner, the control element labeled by the number 5 may be set as an anchor element to be selected, which may be shown in the right image of FIG. 3.

The manner of setting the anchor elements in the element control region shown in FIG. 3 is an exemplary illustration. Other manners may be used to set the anchor elements in the element control region, which is not limited herein.

In some embodiments, based on the computer device's division of anchor elements and non-anchor elements in the element control region, the computer device may further highlight the anchor elements in the element control region based on displaying the plurality of control elements according to the corresponding layout. In some embodiments, in a case that the element control region is a physical key region, highlighting the anchor elements in the element control region includes one or more of the following: adding highlight identifiers (such as highlight horizontal lines and the like) to the displayed anchor elements, or using different shapes to display anchor elements (for example, physical keys corresponding to the anchor elements are displayed in circles, while physical keys of non-anchor elements are displayed in rectangles). In some embodiments, if the element control region is a touch region, the manner of highlighting touch anchors (for example, touchable control elements) in the touch region may be: using different touch experience to highlight the touch anchors, for example, the anchor elements may be displayed with glitchy touch experience, while non-anchor elements may be displayed with smooth touch experience. Based on the highlighting of the anchor elements in the element control region by the computer device, the corresponding execution object can quickly locate the anchor elements in the element control region, thereby improving the execution object's efficiency in determination of output information of an acted control element.

Based on the layout display of the element control region including anchor elements and non-anchor elements by the computer device, the triggering operation may be acquired from the element control region, for example, operation 202 is performed. Based on the acquired triggering operation, the computer device may output a vibration corresponding to each acted control element, to cause the execution object of the operation to determine element information corresponding to each acted control element.

202: Receive a triggering operation performed on a control element in the element control region.

Based on the display of the element control region by the computer device, based on the element control region being a physical key region, the computer device may acquire the triggering operation by detecting a change of the key state in the physical key region, and may acquire the triggering operation through screen reading based on the element control region displayed on the computer device being a touch region.

In some embodiments, the triggering operation acquired by the computer device includes performing a sequential selection operation on the control elements based on the layout of the element control region, and any one of the at least one control element that is sequentially selected is the acted control element. Based on each control element being selected, the computer device outputs a vibration associated with the control element, and perform feedback on the selection operation through a vibration, which can improve the feedback effect of the execution object during control element selection. Based on the element control region being a touch region, the triggering operation further includes a touch movement operation, and any one of the at least one control element that the movement track of the touch movement operation travels through is an acted control element, for example, during the execution of the touch movement operation, each time a control element is traveled through, the computer device outputs a vibration corresponding to the traveled-through control element. For example, the execution object may perform positioning through vibration experience of the anchor elements through the movement operation, thereby improving the accuracy based on the execution object performing control element triggering. For example, based on a blind person performing text input through a touch element, positioning of anchor elements is triggered through the movement operation, to determine positions of touch elements according to the positions of the anchor elements and the layout of the element control region.

Based on acquiring the executed triggering operation from the element control region, the computer device may determine a target anchor element from the at least one anchor element included in the element control region based on the triggering operation. In some embodiments, the computer device may use an anchor element that the operation track travels through as a target anchor element based on the operation track corresponding to the triggering operation. If the operation track of the triggering operation travels through one anchor element, the one traveled-through anchor element is the target anchor element; or if the operation track of the triggering operation travels through at least two anchor elements, the at least two traveled-through anchor elements are sequentially used as the target anchor element based on a traveled-through sequence. For example, base on the operation track traveling through a plurality of anchor elements, the computer device updates the target anchor element according to a triggering sequence of the anchor elements, which facilitates the computer device in determining finally outputted output information corresponding to the control element according to the target anchor element and the operation track, thereby ensuring the accuracy of the output information.

In some embodiments, if the anchor setting manner of the control elements in the element control region is shown in the left image of FIG. 3, based on the setting manner of the anchor elements shown in the left image of FIG. 3, if the operation track corresponding to the triggering operation is shown in FIG. 4 and moves from the control element labeled by W to the control element labeled by T through the control element labeled by E, because the anchor elements covered by the operation track is the control element labeled by E, the anchor element labeled by E may be directly used as the target anchor element.

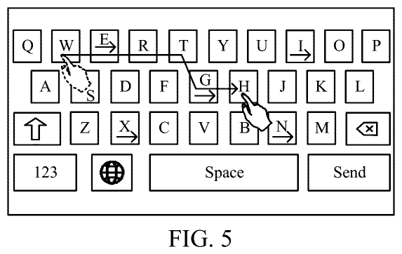

In some embodiments, if the operation track corresponding to the triggering operation is shown in FIG. 5, for example, moving from the control element labeled by W, through the control element labeled by E, and through the control element labeled by G, to the control element labeled by H, in this process, the operation track of the triggering operation travels through two anchor elements, which are respectively the control element labeled by E and the control element labeled by G. Before the triggering operation is performed on the anchor element labeled by G, the target anchor element determined by the computer device is the anchor element labeled by E, and based on the triggering operation being performed on the anchor element labeled by G, the determined target anchor element is the anchor element labeled by G.

In some embodiments, if one anchor element is set in the element control region of the target device (for example, based on a nine-square grid being used for layout, there is one anchor element labeled by the number 5), based on the one anchor element being covered by the operation track of the triggering operation, the one anchor element set in the element control region is directly used as the target anchor element.

In some embodiments, the triggering operation acquired by the computer device may be understood as a pre-selection operation on a corresponding acted control element, and based on the pre-selection on the acted control element by the triggering operation, display of output information corresponding to the corresponding acted control element will not be directly triggered, which is used to trigger the output of a vibration associated with the acted control element. Based on the output information corresponding to the acted control element being determined to be displayed, the display is performed based on the corresponding information output operation being acquired. For the computer device to distinguish between the pre-selection and the information output operation on the acted control element, to avoid the erroneous output of the corresponding information during the triggering operation, the information output operation and the triggering operation for pre-selecting the acted control element acquired by the computer device may be different. For example, based on the pre-selection operation being a sequential selection operation on control elements, the information output operation may be a double-click operation or a long-press operation, and in a case that the pre-selection operation is a touch movement operation, the information output operation may be a touch lift operation.

In some embodiments, based on the element control region of the target device being a touch region, and the control elements included in the element control region are touch elements, the computer device will further acquire a touch event from the touch region, determine whether the touch event includes the touch movement operation, based on determining that the touch event includes the touch movement operation, determine that a triggering operation performed on a touch element in the touch region is received, and further perform vibration output based on the touch element currently moved to, for example, perform operation 203.

In some embodiments, the computer device preset corresponding vibration waveforms for the control elements in the element control region, so that based on the triggering operation acting on a corresponding control element, a corresponding vibration may be outputted based on the corresponding vibration waveform, and based on the anchor element settings in the element control region, the computer device may respectively set different vibration waveforms for anchor elements and non-anchor elements in the element control region. Vibration waveforms set by the computer device for the anchor elements are set based on output information corresponding to the anchor elements. For example, the computer device will set different vibration waveforms for anchor elements corresponding to different output information, for example, respectively set different vibration waveforms for the anchor element labeled by E and the anchor element labeled by I, so that the execution object can determine an anchor element that is currently covered based on the vibration waveform outputted by the anchor element, and the execution object can also determine the current target position based on the outputted vibration based on the triggering operation being performed on the anchor element. For non-anchor elements, the vibration waveforms of the non-anchor elements may correspond to the same vibration waveform, to improve the efficiency of vibration encoding. For example, the control element labeled by Q and the control element labeled by W are both non-anchor elements, and the control element labeled by Q and the control element labeled by W are set with the same vibration waveform. Because a vibration waveform set for a non-anchor element and a vibration waveform set for an anchor element are different, the execution object can distinguish between the anchor element and the non-anchor element based on the output of the vibration waveform corresponding to the non-anchor element.

In some embodiments, control elements may be further divided into a text type and a non-text type according to the information types correspondingly outputted by the control elements. Control elements of which output information is of the text type refer to control elements corresponding to text output, while control elements of which output information is of the non-text type refer to control elements for operational control, such as a control element for information deletion, or a control element for mode conversion. The computer device may set a corresponding vibration waveform for control elements of one information type respectively based on the information types (including the text type and the non-text type) corresponding outputted by the control elements, for example, set a corresponding vibration waveform for control elements of the text type, and set another corresponding vibration waveform for control elements of the non-text type.

For example, an example in which the non-anchor elements include output information of a plurality of information types is used. Based on types of the control elements included in the element control region, the computer device may set vibration waveforms in the following manner:

(1) Anchor elements: For the anchor elements set in the full keyboard distribution case, vibration waveforms set for different anchor elements are distinguished in effects to an extent, so that the execution object can distinguish the element control region based on the set difference between vibration effects corresponding to the anchor elements.

(2) Non-anchor elements of the text type (for example, control elements of the text type): They are all set to simple short vibration waveforms, which allows the execution object to determine the non-anchor elements with reference to anchor positions and a movement direction corresponding to the touch operation.

(3) Non-anchor elements of the non-text type (for example, control elements of the non-text type): They are all set to vibration waveforms, which allows the execution object to determine a non-anchor element of a non-text type with reference to an anchor position and a movement direction corresponding to the touch operation.

In some embodiments, based on the computer device setting the corresponding vibration waveform for the control elements in the full keyboard mode, encoding processing may be performed according to the vibration encoding rules shown in Table 1, to obtain a corresponding vibration description file, so that based on the computer device outputting a vibration, vibration output can be performed directly based on the vibration description file.

TABLE 1

| Control | Waveform | Vibration | Vibration | |
|---|---|---|---|---|
| element | description | intensity | frequency | Encode |
| Anchor | Three powerful short | 80 | 20 | 100 ms short vibration |
| element G/ | vibrations | | | 100 ms short vibration |
| Anchor | | | | 100 ms short vibration |
| element 5 | | | | |
| Anchor | Two crisp short | 50 | 70 | 50 ms vibration |
| element E | vibrations, crisper | | | 50 ms vibration |
| | and weaker than the | | | |
| | vibration effect of | | | |
| | the anchor element | | | |
| | G | | | |
| Anchor | Short vibration + | 50 | 70 | 50 ms vibration |
| element I | long vibration, | | | 200 ms vibration |
| | crisper and weaker | | | |
| | than the vibration | | | |
| | effect of the anchor | | | |
| | element G | | | |
| Anchor | Long vibration + | 50 | 70 | 200 ms vibration |
| element X | short vibration, | | | 50 ms vibration |
| | crisper and weaker | | | |
| | than the vibration | | | |
| | effect of the anchor | | | |
| | element G | | | |
| Anchor | Two long vibrations, | 50 | 70 | 200 ms vibration |
| element N | crisper and weaker | | | 200 ms vibration |
| | than the vibration | | | |
| | effect of the anchor | | | |
| | element G | | | |
| Text type | Slight short vibration | 20 | 100 | 50 ms vibration |
| non-anchor | | | | |
| Non-text type | Powerful long | 70 | 20 | 200 ms vibration |
| non-anchor | vibration | | | |

Based on the foregoing encoding rules, the computer device may use the following code to describe corresponding vibration waveforms and generate corresponding vibration description files. For example, the vibration effect of the anchor element G is three vibrations with an intensity of 80, a frequency of 20, and a duration of 100 ms, the vibration recorded in the vibration description file generated by the encoding is: 15 {80 20 100} {0 0 50} {80 20 100} {0 0 50} {80 20 100}. The description code of the vibration waveform is as follows:

```
  hqh_main_ver//encoding version number
  if(hqh_main_ver==1)
  hqh_count//included vibration fragments
  for(i=0;i<hqh_count;i++)
  hqh_haptics_insit//vibration intensity, 0 means no vibration, 1 means the
minimum intensity vibration supported by the current device, and 100 means the maximum
intensity vibration
  hqh_haptics_freq//vibration frequency, 0 means no vibration, 1 means the
minimum frequency supported by the current device, 100 means the maximum frequency
  hqh_haptics_dura//vibration duration, the unit is milliseconds
```

The foregoing description code indicates that: the encoding version number is first generated, based on the encoding version number being 1, a counting parameter corresponding to the vibration fragment is defined, and in a case that i is less than the counting parameter, a vibration with the specified vibration intensity, vibration frequency, and vibration duration is cyclically performed.

Based on the setting of the vibration waveforms of the control elements in the element control region by the computer device, based on the computer device receiving the triggering operation performed on a control element in the element control region, each time a control element is acted on, a vibration associated with the acted control element may be outputted, and based on the difference in vibration effects corresponding to the vibration waveforms set for the anchor elements and the non-anchor elements in the element control region, anchor positioning may be performed in the element control region based a vibration of an anchor element. Due to the fixed layout between other non-anchor elements and the anchor element, the execution object may search for the target non-anchor by sliding in different directions, and may also perform information output control based on the outputted vibration, to improve the flexibility of the computer in information output reminding.

203: Output, based on the triggering operation acting on at least one of the plurality of control elements, a vibration associated with the at least one control element, based on the acted control element being the anchor element, output information being indicated by an anchor vibration correspondingly outputted by the acted anchor element; and based on the acted control element being the non-anchor element, output information being indicated by the anchor vibration, a layout of the element control region, and an operation track of the triggering operation.

Based on the computer device outputting the vibration associated with the acted control element, based on the foregoing setting manner of the vibration waveforms corresponding to the control elements in the element control region, if the acted control element is an anchor element, the corresponding execution object may directly determine output information corresponding to the current acted control element based on the outputted anchor vibration. If the current acted control element is a non-anchor element, based on the execution object determining output information corresponding to the acted non-anchor element, the determining may be performed with reference to the outputted anchor vibration, the layout manner of the element control region, and the operation track of the triggering operation. The acted control element is any one of the at least one control element.

In some embodiments, the layout of the element control region is configured for indicating display positions of the plurality of control elements in the element control region, the element control region includes a plurality of display positions, one display position corresponds to one control element, the anchor element acted on by the triggering operation may be a target anchor element, and the target anchor element is displayed at a target position of the element control region, based on the acted control element further including at least one non-anchor element, based on the current acted control element being a non-anchor element, output information of any acted non-anchor element is indicated by positioning of the corresponding non-anchor element. Based on the computer device performing positioning on the any acted non-anchor element, a quantity of elements between the target anchor element and the acted non-anchor element may be first acquired, and by using the target position as a reference position, a display position along the operation track of the triggering operation and spaced by the quantity of elements is used as positioning of the acted non-anchor element. In some embodiments, based on the acted control element being a non-anchor element, the computer device will also output a vibration (for example, a control element vibration) corresponding to the acted non-anchor element. The quantity of elements between the target anchor element and the acted non-anchor element acquired by the computer device may be determined based on the quantity of vibrations outputted during the execution of the triggering operation. Based on the quantity of vibrations experienced between an anchor element and a non-anchor element of which information is to be outputted, the quantity of elements between the anchor element and the non-anchor element is quickly determined, thereby quickly realizing positioning of the control element, and improving the efficiency of transferring control element information.

In some embodiments, based on the anchor elements set in the element control region, the execution object may locate the anchor elements based on vibrations, and locate other non-anchor elements based on movements. For example, for the letter A (a non-anchor element) in the full keyboard, based on different positioning anchors and different movement manners, there may be a plurality of path selections as follows for confirmation:
(1) Locate the anchor element E, move to the left to locate the control element W, move to the lower left to locate the control element A, and raise a hand to complete the input. The vibration effects triggered in the process are: E (anchor vibration), W (control element vibration), A (control element vibration).
(2) Locate the anchor element E, move to the lower left to locate the control element S, move to the left to locate the control element A, and raise a hand to complete the input. The vibration effects triggered in the process are: E (anchor vibration), S (control element vibration), A (control element vibration).
(3) Locate the anchor element X, move to the left to locate the control element Z, move to the upper left to locate the control element A, and raise a hand to complete the input. The vibration effects triggered in the process are: X (anchor vibration), Z (control element vibration), A (control element vibration).
(4) Locate the anchor element X, move to the upper left to locate the control element S, move to the left to locate the control element A, and raise a hand to complete the input. The vibration effects triggered in the process are: X (anchor vibration), S (control element vibration), A (control element vibration).

In addition, for locating control elements of the non-text type, if a last piece of input information is to be deleted, the control element labeled by N may be first located, and the control element labeled by M may be reached by moving right, and the control element corresponding to the delete operation may be reached by moving right. The vibration effects triggered in the process are: N (anchor vibration), M (control element vibration), delete key (control element vibration of the non-text type). For output of control elements of the nine-square grid layout, for example, the number 8 may be located in the nine-square grid: locate the anchor element 5, and move down to the control element labeled by 8. The vibration effects triggered in the process are: 5 (anchor vibration), 8 (control element vibration). Based on the problem of locating a non-anchor element before the triggering operation is performed on the target anchor element, similarly, reverse deduction may be performed with reference to the layout of the element control region, the operation track of the triggering operation and the anchor vibration, and a positioning result of the non-anchor element before the target anchor element can be obtained.

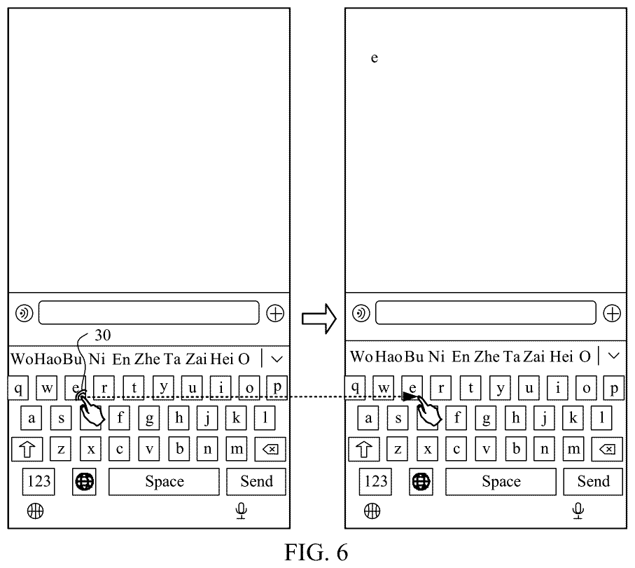

Based on the positioning of the acted non-anchor element, the output information corresponding to the current acted non-anchor element can be further obtained, and determining of the output information of the acted control element based on the computer device is realized based on the received information output operation. For example, in response to acquiring an information output operation, the output information corresponding to the acted control element is determined as information that is to be outputted, and the output information corresponding to the acted control element is displayed. In some embodiments, in a case that the element control region is a touch region and the triggering operation is a touch movement operation, the acquired information output operation includes a touch lift operation, and based on the computer device determining that output information corresponding to the acted control element is to be outputted, the process of triggering display of the corresponding output information may be shown in FIG. 6. In FIG. 6, to exemplarily illustrate whether to perform the triggering operation, a control element that is acted on by the triggering operation and a control element that is not acted on by the triggering operation may be displayed in a differentiated manner, for example, a corresponding identifier (for example, a triggering identifier labeled by 30 in FIG. 6) may be used, to perform labeling based on the triggering operation acting on the corresponding control element. Based on the information output operation being touch lift operation, it means stopping the triggering effect on the corresponding control element. It can be as shown in FIG. 6, based on the touch lift operation being performed, the display of the triggering identifier is canceled and the display of output information corresponding to the corresponding control element is triggered.

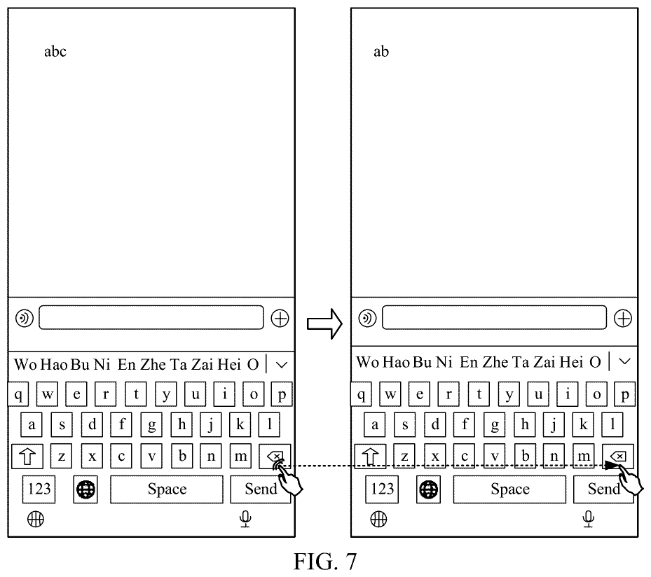

In a case that the current acted control element is a non-anchor element, there are two types of output information corresponding to the acted control element: one is the text type and the other is the non-text type. Based on the information type correspondingly outputted by the acted control element being the text type, based on the computer device displaying the output information corresponding to the acted control element, the output text corresponding to the acted control element is displayed as shown in FIG. 6. Based on the information type correspondingly outputted by the acted control element being the non-text type, based on the computer device displaying the output information corresponding to the acted control element, the operation indicated by the acted control element is performed, which may be shown in FIG. 7. If the operation indicated by the acted control element is a delete operation, the display of the acted control element with the delete operation is to perform the delete operation, for example, to perform a delete operation on the displayed information.

In some embodiments, the output information corresponding to the acted control element is displayed based on a validity determination that is performed on the information output operation. During the validity determining on the information output operation, the computer device may first acquire an operation position of the information output operation, and based on the operation position of the information output operation being a display position corresponding to the acted control element, determine that the validity determining succeeds; otherwise, determine that the validity determining fails. The validity determining is used to determine whether to display the output information, thereby ensuring accuracy of information output.

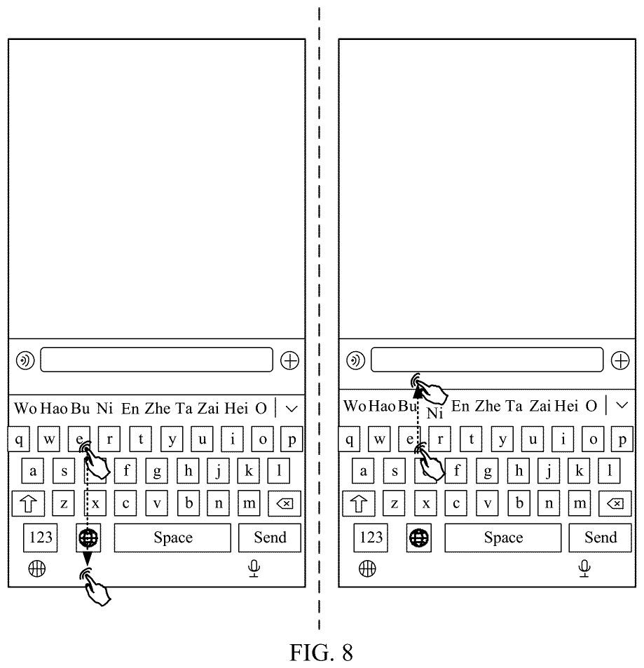

In some embodiments, an output cancellation operation may be used to indicate cancellation of output of the output information triggered by the triggering operation for output. For example, in response to acquiring the output cancellation operation, it is determined that the output information corresponding to the acted control element is not the information that is to be outputted, for example, if the computer device determines that the output information corresponding to the acted control element is not the information that is to be outputted, the output cancellation operation is acquired and the output information corresponding to the acted control element is not displayed. The cancellation operation may be, for example, a long press operation or the like. In some embodiments, the output cancellation is realized by triggering a target region in the element control region. In some embodiments, one display position of the layout of the element control region corresponds to one control element. Display positions corresponding to control elements in the element control region are a layout region of the element control region, and display positions corresponding to no control elements (for example, positions at which no control elements are laid out) are a blank region of the element control region. In a case that the element control region is a touch region and the triggering operation is a touch movement operation, the computer device may determine the acquisition of an input cancellation operation based on detecting an operation of moving from the layout region in which the acted control element is located to the blank region, which may be shown in any interface in FIG. 8. Based on the triggering operation being determined to perform a sequential selection operation on the control elements, the computer device may determine the acquisition of an input cancellation operation based on acquiring a selection cancellation operation (such as the foregoing long press operation or the like) on the acted control element. For example, during the touch movement, the movement track is extended to the blank region outside the layout region to cancel the triggering of the control element. The computer device is to detect a region in which the final touch point of the touch movement operation is located to determine whether the output information corresponding to the control element is displayed or not, which improves the execution efficiency of canceling triggering of the control element in the case of incorrect input.

In some embodiments, based on outputting a vibration associated with the acted control element, the computer device may also acquire an output scenario during information output, and may perform vibration output with reference to the output scenario. Based on the output scenario not supporting audio output, the computer device may output the vibration associated with the acted control element; in addition, based on the output scenario supporting audio output, the computer device may output the vibration associated with the acted control element, and output a description audio corresponding to a control element that indicates output in the at least one control element. The description audio is configured for indicating the output information of the acted control element. For example, the computer device outputs the vibration and the description audio corresponding to the final output information. By determining the output scenario of the information output in which the computer device is located, in a scenario that supports audio output, the vibration and the description audio are combined to assist the execution object in recognizing triggering of the control element, which improves diversity of prompts in a case that the output scenario permits, and is adapted to different aspects of the output scenario. For example, based on the computer device detecting environmental sound and determines that the surrounding noise is lower than a specified noise threshold, it is determined that the output scenario supports audio output; and based on the computer device determining that the surrounding noise is higher than the specified noise threshold, whether a headphone device is connected is determined, if a headphone device is connected, it is determined that the output scenario supports audio output, and if no headphone device is connected, it is determined that the output scenario does not support audio output.

In some embodiments, based on outputting the vibration associated with the acted control element, the computer device outputs, according to a vibration duration, a vibration intensity, and a vibration frequency specified by the vibration associated with the acted control element, a vibration with the same vibration duration, the same vibration intensity, and the same vibration frequency. The computer device may acquire a vibration waveform associated with the acted control element to obtain the vibration duration, the vibration intensity, and the vibration frequency specified by the vibration associated with the acted control element. The manner of acquiring the reference vibration waveform corresponding to the vibration associated with the acted control element includes: first acquiring the element type of the acted control element, the element type including an anchor type and a non-anchor type; and based on the element type of the acted control element being the anchor type, acquiring a reference vibration waveform according to the output information corresponding to the acted anchor type. The computer device may first acquire output information corresponding to the acted anchor type, acquire a vibration description file set for the output information corresponding to the acted anchor type, the acquired vibration description file being configured for describing values of the vibration duration, the vibration intensity, and the vibration frequency; and may generate a reference vibration waveform based on the values corresponding to the vibration duration, the vibration intensity, and the vibration frequency described in the vibration description file. The computer device is controlled to vibrate according to the acted control element based on pre-stored reference vibration waveforms, which improves the feedback efficiency of vibration feedback of the computer device.

In some embodiments, if the element type of the acted control element is a non-anchor type, the computer device may acquire the reference vibration waveform according to a type of output information corresponding to the acted non-anchor type. The computer device may first acquire an information type outputted by the applied non-anchor type, the information type including a text type or a non-text type. A vibration waveform matched for an acted non-anchor type that outputs information of the text type is different from a vibration waveform matched for an acted non-anchor type that outputs information of the non-text type, for example, different vibration effects are realized through different vibration waveforms to quickly distinguish control elements of the text type and the non-text type, which improves the recognition efficiency of control element types. The computer device may acquire a vibration waveform matching the information type outputted by the acted non-anchor type, and use the acquired vibration waveform as a reference vibration waveform. In some embodiments, the process in which the computer device acquires the vibration waveform corresponding to the acted control element is also a process of acquiring the corresponding vibration description file, and a vibration motor may be driven to realize vibration output based on the stipulation of the vibration description file on the vibration duration, the vibration intensity, and the vibration frequency.

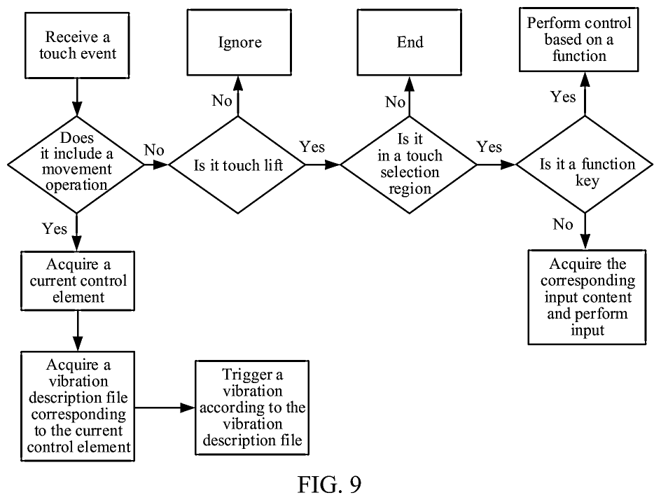

Based on the element control region displayed by the computer device being a touch region, the control elements included in the element control region are touch elements. A process in which the computer device performs vibration output based on a triggering operation performed by an execution object to cause the execution object to perform positioning and vibration control in conjunction with an outputted vibration is described below with reference to FIG. 9. First, the computer device may acquire a touch event from the touch region and determine whether the touch event includes a movement operation. If it is determined that the touch event includes a touch movement operation, it can be determined that the triggering operation is acquired from the touch region. During the execution of the touch movement operation, the control elements covered by the corresponding movement track are the acted control elements, and the computer device will output corresponding vibrations. For the execution object to effectively determine all the acted control elements (including non-anchor elements) in the movement process, the target anchor element may first be determined based on the outputted vibration, and based on the anchor vibration outputted by the target anchor element and with reference to the movement track, positioning of the non-anchor element after the target anchor element in the touch region and the corresponding output information may be determined, or the positioning of the non-anchor element after the target anchor element in the touch region and the corresponding output information may be reversely deduced.

Based on the determining of the information of the acted control element, the computer device may further determine whether to perform information output of the current acted control element based on a relevant operation of the execution object. The computer device may determine to display the output information of the acted control element during the touch lift operation and based on the current triggering operation corresponding to the display position of the acted control element. In addition, based on displaying the output information of the acted control element, the computer device may further determine whether the acted control element is of the non-text type. Based on determining that the acted control element is of the non-text type, information control is performed based on the corresponding operation. Based on determining that the acted control element is not of the non-text type, it can be determined that the acted control element is of the text type, and display may be performed based on the input text corresponding to the reference control element.

In some embodiments, based on displaying an element control region, a computer device may acquire a triggering operation on a control element from the element control region, and may determine an acted anchor element from the element control region based on the triggering operation, and output an anchor vibration corresponding to the acted anchor element, so that the execution object may determine an execution position of the current triggering operation based on the outputted anchor vibration; and based on the triggering operation being performed on one anchor element, and based on the triggering operation acting on other non-anchor elements, the computer device may determine positioning of the current acted non-anchor element and corresponding output information based on a layout of the element control region, an operation track corresponding to the triggering operation, and an outputted anchor vibration, to improve flexibility of feedback during selection on control elements, and also to enable the computer device to output different vibration feedback to remind output information corresponding to the corresponding control elements, which helps to improve the effectiveness and flexibility of reminding for the input information while ensuring information security, so that reminding for output information corresponding to control elements are no longer limited by noisy environments, thereby effectively protecting the information security of the corresponding execution object.

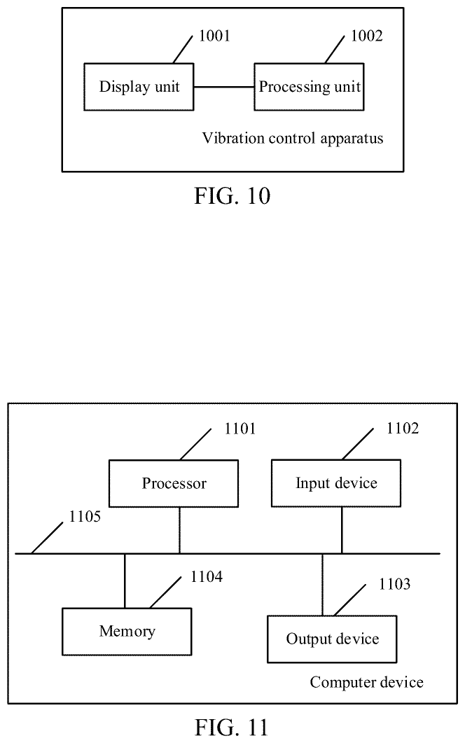

Based on the foregoing descriptions, some embodiments further provide a vibration control apparatus. The vibration control apparatus may be a computer program (including program code) run on the foregoing computer device. The vibration control apparatus may be configured to perform the vibration control method shown in FIG. 2. Referring to FIG. 10, the vibration control apparatus includes: a display unit 1001 and a processing unit 1002.
a display unit 1001, configured to display an element control region, a plurality of control elements being laid out in the element control region, the control elements being anchor elements or non-anchor elements; and
a processing unit 1002, configured to receive a triggering operation performed on a control element in the element control region; and output, based on the triggering operation acting on at least one control element, a vibration associated with the at least one control element,
based on the acted control element being the anchor element, output information being indicated by an anchor vibration correspondingly outputted by the acted anchor element; and based on the acted control element being the non-anchor element, output information being indicated by the anchor vibration, a layout of the element control region, and an operation track of the triggering operation.

In some embodiments, the triggering operation includes performing a sequential selection operation on the control elements based on the layout of the element control region, and any one of the at least one control element that is sequentially selected is the acted control element; or
based on the element control region being a touch region, the triggering operation further includes a touch movement operation, and any one of the at least one control element that a movement track of the touch movement operation travels through is the acted control element.

In some embodiments, the processing unit 1002 is further configured to: in response to acquiring an information output operation, determine the output information corresponding to the acted control element as information that is to be outputted, and display the output information corresponding to the acted control element; or
the processing unit 1002 is further configured to: in response to acquiring an output cancellation operation, determine that the output information corresponding to the acted control element is not the information that is to be outputted.

In some embodiments, the processing unit 1002 is further configured to: if an information type outputted by the acted control element is a text type, display output text corresponding to the acted control element; or
the processing unit 1002 is further configured to: if the information type outputted by the acted control element is a non-text type, perform an operation indicated by the acted control element.

In some embodiments, the element control region includes a layout region and a blank region, the control elements being laid out in the layout region, and no control element being laid out in the blank region; and
based on the element control region being the touch region, and the triggering operation is the touch movement operation, the output cancellation operation includes: an operation of moving from the layout region at which the acted control element is located to the blank region; or
based on the triggering operation being performing the sequential selection operation on the control elements, the output cancellation operation includes: a selection cancellation operation on the acted control element.

In some embodiments, the processing unit 1002 is further configured to:
acquire an output scenario during information output;
output the vibration associated with the at least one control element based on the output scenario not supporting audio output; or
output the vibration associated with the at least one control element based on the output scenario supporting audio output, and output a description audio corresponding to a control element that indicates output in the at least one control element, the description audio being configured for indicating output information of the control element.

In some embodiments, the processing unit 1002 is further configured to:
outputting, according to a vibration duration, a vibration intensity, and a vibration frequency specified by a vibration associated with the acted control element, a vibration with the same vibration duration, the same vibration intensity, and the same vibration frequency.

In some embodiments, the vibration associated with the acted control element is outputted according to a reference vibration waveform, the reference vibration waveform being determined according to the vibration duration, the vibration intensity, and the vibration frequency specified by the vibration associated with the acted control element; and the processing unit 1002 is further configured to:
acquire an element type of the acted control element, the element type including an anchor type and a non-anchor type; and
acquire a reference vibration waveform according to the output information corresponding to the acted control element based on the element type of the acted control element being the anchor type; or
acquire a reference vibration waveform according to a type of the output information corresponding to the acted control element based on the element type of the acted control element being the non-anchor type.

In some embodiments, based on the element type of the acted control element being the anchor type, the acted control element is an acted anchor element; and the processing unit 1002 is further configured to:
based on the element type of the acted control element being the anchor type, acquire output information corresponding to the acted anchor element, and acquire a vibration description file set for the output information corresponding to the acted anchor element, the acquired vibration description file being configured for describing values of the vibration duration, the vibration intensity, and the vibration frequency; and
generate a reference vibration waveform based on the values corresponding to the vibration duration, the vibration intensity, and the vibration frequency described in the vibration description file.

In some embodiments, based on the element type of the acted control element being the non-anchor type, the acted control element is an acted non-anchor element; and the processing unit 1002 is further configured to:
based on the element type of the acted control element being the non-anchor type, acquire an information type outputted by the acted non-anchor element, the information type including a text type or a non-text type, a vibration waveform matched for a non-anchor element of which output information is of the text type being different from a vibration waveform matched for a non-anchor element of which output information is of the non-text type; and
acquire a vibration waveform matching the information type outputted by the acted non-anchor element, and use the acquired vibration waveform as a reference vibration waveform.

In some embodiments, the layout of the element control region is configured for indicating display positions of the plurality of control elements in the element control region, the element control region includes a plurality of display positions, one display position corresponds to one control element, the at least one control element includes a target anchor element, the target anchor element is displayed at a target position of the element control region, and based on the acted control element further including at least one non-anchor element, output information of any acted non-anchor element is indicated by positioning of the corresponding non-anchor element; and the processing unit 1002 is further configured to:
acquire a quantity of elements between the target anchor element and the acted non-anchor element; and
use, with the target position as a reference position, a display position along the operation track of the triggering operation and spaced by the quantity of elements as positioning of the acted non-anchor element.

In some embodiments, if the operation track of the triggering operation travels through one anchor element, the one traveled-through anchor element is the target anchor element; or
if the operation track of the triggering operation travels through at least two anchor elements, the at least two traveled-through anchor elements are sequentially used as the target anchor element based on a traveled-through sequence.

In some embodiments, based on the element control region of a target device being the touch region, the control elements included in the element control region are touch elements; and the processing unit 1002 is further configured to acquire a touch event from the touch region, and determine whether the touch event includes the touch movement operation; and
the processing unit 1002 is further configured to determine, based on determining that the touch event includes the touch movement operation, that a triggering operation performed on a touch element in the touch region is received.

In some embodiments, the output information corresponding to the acted control element is displayed based on a validity determination being performed on the information output operation; and the processing unit 1002 is further configured to:
acquire an operation position of the information output operation, and based on the operation position of the information output operation being a display position corresponding to the acted control element, determine that the validity determining succeeds; or
based on the operation position not being the display position, determine that the validity determining fails.

In some embodiments, based on the display unit 1001 displaying an element control region, the processing unit 1002 may acquire a triggering operation on a control element from the element control region, and may determine an acted anchor element from the element control region based on the triggering operation, and output an anchor vibration corresponding to the acted anchor element, so that the execution object may determine an execution position of the current triggering operation based on the outputted anchor vibration; and based on the triggering operation being performed on one anchor element, and based on the triggering operation acting on other non-anchor elements the processing unit 1002 may determine positioning of the current acted non-anchor element and corresponding output information based on a layout of the element control region, an operation track corresponding to the triggering operation, and an outputted anchor vibration, to improve flexibility of feedback during selection on control elements, and also to output different vibration feedback to remind output information corresponding to the corresponding control elements, which helps to improve the effectiveness and flexibility of reminding for the input information while ensuring information security, so that reminding for output information corresponding to control elements are no longer limited by noisy environments, thereby effectively protecting the information security of the corresponding execution object.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

FIG. 11 is a schematic structural block diagram of a computer device according to some embodiments. The computer device according to some embodiments as shown in FIG. 11, may include: one or more processors 1101, one or more input devices 1102, one or more output devices 1103, and a memory 1104. The processor 1101, the input device 1102, the output device 1103, and the memory 1104 are connected through a bus 1105. The memory 1104 is configured to store a computer program, and the computer program includes program instructions. The processor 1101 is configured to execute the program instructions stored in the memory 1104.

The memory 1104 may include a volatile memory, for example, a random access memory (RAM). The memory 1104 may include a non-volatile memory, for example, a flash memory, or a solid-state drive (SSD). The memory 1104 may include a combination of the foregoing types of memories.

The processor 1101 may be a central processing unit (CPU). The processor 1101 may further include a hardware chip. The foregoing hardware chip may be an application-specific integrated circuit (ASIC), a programmable logic device (PLD), or the like. The PLD may be a field programmable gate array (FPGA), generic array logic (GAL), or the like. The processor 1101 may be a combination of the foregoing structures.

In some embodiments, the memory 1104 is configured to store a computer program. The computer program includes program instructions. The processor 1101 is configured to execute the program instructions stored in the memory 1104, to implement the vibration control method provided in the method embodiments.

Some embodiments provide a computer-readable storage medium, the computer-readable storage medium storing at least one instruction, at least one program, a code set or an instruction set, the at least one instruction, the at least one program, the code set or the instruction set being loaded and executed by a processor to implement the vibration control method according to some embodiments.

Some embodiments provide a computer program product or a computer program. The computer program product or the computer program includes computer instructions, the computer instructions being stored in a computer-readable storage medium. A processor of a computer device reads the computer instructions from the computer-readable storage medium and executes the computer instructions to cause the computer device to perform the vibration control method according to some embodiments. The computer-readable storage medium may be a magnetic disk, an optical disc, a read-only memory (Read-Only Memory, ROM), a random access memory (Random Access Memory, RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A vibration control method, comprising:
displaying an element control region comprising a first plurality of control elements, wherein the first plurality of control elements comprises one or more anchor elements and a plurality of non-anchor elements;
receiving a triggering operation performed on a first control element of the first plurality of control elements; and
outputting a vibration associated with at least one acted control element of the first plurality of control elements based on the triggering operation acting on at least one of the first plurality of control elements,
wherein, based on the at least one acted control element being an anchor element,
the outputting the vibration comprises outputting an anchor vibration; and
the method further comprises determining output information corresponding to the at least one acted control element based on the anchor vibration, and
wherein, based on the at least one acted control element being a non-anchor element, the method further comprises determining the output information based on the anchor vibration, a layout of the element control region, and an operation track of the triggering operation.

2. The method according to claim 1, wherein the triggering operation comprises performing a sequential selection operation on a second plurality of control elements of the first plurality of control elements based on the layout of the element control region, wherein one of the second plurality of control elements is the at least one acted control element, and
wherein, based on the element control region being a touch region, the triggering operation further comprises performing a touch movement operation on a third plurality of control elements of the first plurality of control elements, wherein one of the third plurality of control elements is the at least one acted control element.

3. The method according to claim 2, further comprising:
based on acquiring an information output operation,
determining the output information is to be output; and
displaying the output information; or
based on acquiring an output cancellation operation, determining the output information is not to be output.

4. The method according to claim 3, wherein based on an information type of the output information being a text type, the displaying the output information comprises displaying output text corresponding to the at least one acted control element; or
based on the information type of the output information being a non-text type, the displaying the output information comprises performing a corresponding operation of the at least one acted control element.

5. The method according to claim 3, wherein the element control region comprises a layout region and a blank region,
wherein the layout region comprises the first plurality of control elements,
wherein none of the first plurality of control elements are included in the blank region, and
wherein the output cancellation operation comprises:
based on the element control region being the touch region and the triggering operation being the touch movement operation, moving from a location of the layout region comprising the at least one acted control element to the blank region; or
based on the triggering operation being the sequential selection operation, performing a selection cancellation operation on the at least one acted control element.

6. The method according to claim 1, wherein the outputting the vibration comprises:
acquiring an output scenario during information output, and
performing at least one of:
outputting the vibration based on the output scenario not supporting audio output; or
outputting the vibration based on the output scenario supporting audio output, and outputting a description audio corresponding to a second control element of the first plurality of control elements that indicates output in the at least one acted control element, and
wherein the description audio indicates second output information of the second control element.

7. The method according to claim 1, wherein a plurality of vibration properties are associated with the at least one acted control element,
wherein the plurality of vibration properties comprise a vibration duration, a vibration intensity, and a vibration frequency, and
wherein the outputting the vibration comprises outputting the vibration according to the plurality of vibration properties.

8. The method according to claim 7, wherein the method further comprises acquiring a reference vibration waveform determined according to the plurality of vibration properties,
wherein the vibration is output according to the reference vibration waveform,
wherein the acquiring the reference vibration waveform comprises acquiring an element type of the at least one acted control element,
wherein the element type is an anchor type or a non-anchor type, and
wherein the acquiring the reference vibration waveform further comprises:
acquiring a first reference vibration waveform according to the output information based on the element type being the anchor type; or
acquiring a second reference vibration waveform according to an information type of the output information based on the element type being the non-anchor type.

9. The method according to claim 8, wherein the acquiring the first reference vibration waveform comprises:
acquiring first output information corresponding to the at least one acted control element;
acquiring a vibration description file set for the first output information that indicates a plurality of values corresponding to the plurality of vibration properties; and
generating a third reference vibration waveform based on the plurality of values.

10. The method according to claim 8, wherein the acquiring the second reference vibration waveform comprises:
acquiring an information type output by the at least one acted control element comprising a text type or a non-text type;
acquiring a third vibration waveform corresponding to the information type; and
using the third vibration waveform as the second reference vibration waveform,
wherein first output information corresponding to the at least one acted control element is of the text type, and
wherein a fourth vibration waveform is different for second output information corresponding to the non-text type.

11. A vibration control apparatus, comprising:
at least one memory configured to store computer program code; and
at least one processor configured to read the program code and operate as instructed by the program code, the program code comprising:
display code configured to cause at least one of the at least one processor to display an element control region comprising a first plurality of control elements, wherein the first plurality of control elements comprise one or more anchor elements and a plurality of non-anchor elements non-anchor elements;
triggering code configured to cause at least one of the at least one processor to receive a triggering operation performed on a first control element of the first plurality of control elements; and
first output code configured to cause at least one of the at least one processor to output a vibration associated with at least one acted control element of the first plurality of control elements based on the triggering operation acting on at least one of the first plurality of control elements, and
wherein the first output code is configured to cause at least one of the at least one processor to:
based on the at least one acted control element being an anchor element,
output an anchor vibration; and
determine output information corresponding to the at least one acted control element based on the anchor vibration; and
based on the acted control element being a non-anchor element, determine the output information based on the anchor vibration, a layout of the element control region, and an operation track of the triggering operation.

12. The apparatus according to claim 11, wherein the triggering operation comprises performing a sequential selection operation on a second plurality of control elements of the first plurality of control elements based on the layout of the element control region, wherein one of the second plurality of control elements is the at least one acted control element; and
based on the element control region being a touch region, the triggering operation further comprises performing a touch movement operation on a third plurality of control elements of the first plurality of control elements, wherein one of the third plurality of control elements is the at least one acted control element.

13. The apparatus according to claim 12, further comprising at least one of first determining code or second determining code,
wherein the first determining code is configured to cause at least one of the at least one processor to:
based on acquiring an information output operation, determine the output information is to be output, and
display the output information, and
wherein the second determining code is configured to cause at least one of the at least one processor to, based on acquiring an output cancellation operation, determine the output information is not to be output.

14. The apparatus according to claim 13, wherein the first determining code is configured to cause at least one of the at least one processor to:
based on an information type of the output information being a text type, display output text corresponding to the at least one acted control element; or
based on the information type of the output information being a non-text type, perform a corresponding operation of the at least one acted control element.

15. The apparatus according to claim 13, wherein the element control region comprises a layout region and a blank region,
wherein the layout region comprises the first plurality of control elements,
wherein none of the first plurality of control elements are included in the blank region, and
wherein the output cancellation operation comprises:
based on the element control region being the touch region and the triggering operation being the touch movement operation, moving from a location of the layout region comprising the at least one acted control element to the blank region; or
based on the triggering operation being the sequential selection operation, performing a selection cancellation operation on the at least one acted control element.

16. The apparatus according to claim 11, wherein the first output code is configured to cause at least one of the at least one processor to acquire an output scenario during information output,
wherein the first output code comprises at least one of second output code and third output code,
wherein the second output code is configured to cause at least one of the at least one processor to output the vibration based on the output scenario not supporting audio output,
wherein the third output code is configured to cause at least one of the at least one processor to output the vibration based on the output scenario supporting audio output, and outputting a description audio corresponding to a second control element of the first plurality of control elements that indicates output in the at least one acted control element, and
wherein the description audio indicates second output information of the second control element.

17. The apparatus according to claim 11, wherein a plurality of vibration properties are associated with the at least one acted control element,
wherein the plurality of vibration properties comprise a vibration duration, a vibration intensity, and a vibration frequency, and
wherein the first output code is configured to cause at least one of the at least one processor to output the vibration according to the plurality of vibration properties.

18. The apparatus according to claim 17, wherein the apparatus further comprises first acquiring code configured to cause at least one of the at least one processor to acquire a reference vibration waveform determined according to the plurality of vibration properties,
wherein the vibration is output according to the reference vibration waveform,
wherein the first acquiring code is configured to cause at least one of the at least one processor to acquire the reference vibration waveform based on acquiring an element type of the at least one acted control element,
wherein the element type is an anchor type or a non-anchor type,
wherein the first acquiring code comprises at least one of second acquiring code or third acquiring code,
wherein the second acquiring code is configured to cause at least one of the at least one processor to acquire a first reference vibration waveform according to the output information based on the element type being the anchor type, and
wherein the third acquiring code is configured to cause at least one of the at least one processor to acquire a second reference vibration waveform according to an information type of the output information based on the element type being the non-anchor type.

19. The apparatus according to claim 18, wherein the second acquiring code is configured to cause at least one of the at least one processor to:
acquire first output information corresponding to the at least one acted control element;
acquire a vibration description file set for the first output information that indicates a plurality of values corresponding to the plurality of vibration properties; and
generate a third reference vibration waveform based on the plurality of values.

20. A non-transitory computer-readable storage medium, storing computer code which, when executed by at least one processor, causes the at least one processor to at least:
display an element control region comprising a first plurality of control elements, wherein the first plurality of control elements comprise one or more anchor elements and a plurality of non-anchor elements non-anchor elements;
receive a triggering operation performed on a first control element of the first plurality of control elements; and
output a vibration associated with at least one acted control element of the first plurality of control elements based on the triggering operation acting on at least one of the first plurality of control elements,
wherein, based on the at least one acted control element being an anchor element,
the outputting the vibration comprises outputting an anchor vibration; and
the outputting the vibration further comprises determining output information corresponding to the at least one acted control element based on the anchor vibration, and
wherein, based on the at least one acted control element being a non-anchor element, the outputting the vibration further comprises determining the output information based on the anchor vibration, a layout of the element control region, and an operation track of the triggering operation.
